(19) United States
(12) Patent Application Publication
(10) Pub. No.: US 2004/0213287 A1
(43) Pub. Date: Oct. 28, 2004

(54) Transmitting method, transmitting apparatus and receiving apparatus

(75) Inventors: Kenji Komori, Tokyo (JP); Yoshinari Kumaki, Kanagawa-ken (JP); Satoshi Uchida, Tokyo (JP); Jun Okazaki, Kanagawa-ken (JP); Manzo Hosojima, Tokyo (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/807,536

(22) Filed: Mar. 24, 2004

(30) Foreign Application Priority Data
Mar. 25, 2003 (JP) 2003-081851

(51) Int. Cl. H04L 12/28

(52) U.S. Cl. 370/466; 370/227

(57) ABSTRACT

A transmitter capable of retransmitting an MPEG2-TS packet up to the reconstruction time limit and a receiver capable of requesting a retransmission of the packet up to the reconstruction time limit are provided by effectively using a waiting time of a packet to be reconstructed. The transmitting apparatus is provided with a timer portion 13 that shows a current time T in a wireless transmission, a time stamp adding portion 17 that adds a time stamp for specifying a time TS(N) for the packet N to be processed at a receiver side to the packet N, and a calculation portion 14 that calculates a packet transmission required time T_P during which the packet N is transmitted from a transmitter side and then received at the receiver side. In a case where a retransmission request of the packet N from the receiver side is issued, the time limit TL for the retransmitted packet to be received in time for the processing at the receiver side is calculated by the equation of TL(N)=TS(N)−T_P. If TL(N)≧T, the packet N is retransmitted. If TL(N)<T, the packet is not retransmitted.

This application is based upon and claims the benefit of priority from prior Japanese Patent Application No. 2003-81851, filed on Mar. 25, 2003, the entire contents of which are incorporated herein by reference.

### BACKGROUND OF THE INVENTION

1. Field of the Invention

The present invention relates to a transmitting apparatus (hereinafter may be referred to as “transmitter”) and a receiving apparatus (hereinafter referred to as “receiver”).

2. Description of Related Art

The following description sets forth the inventor's knowledge of related art and problems therein and should not be construed as an admission of knowledge in the prior art.

MPEG2-TS packets are known as packets used for transferring and reproducing data in real time.

In the case of performing a wireless transfer using the aforementioned MPEG2-TS packets, at first, a wireless conversion processing portion of a transmitter transmits a MPEG2-TS packet to a wireless conversion processing portion of a receiver. If there is an error in the received MPEG2-TS packet, the receiver transmits a retransmission request signal for requesting a retransmission of the MPEG2-TS packet to the transmitter.

Upon receiving the retransmission request signal, the transmitter retransmits the MPEG2-TS packet. The aforementioned operation will be repeated until the receiver properly receives the MPEG2-TS packet.

Since the receiver restructures data in real time while receiving packets, a time during which a packet can stay in a buffer until the restructuring of the packet is limited. Therefore, conventionally, the number of requesting the retransmission request is set to be made within a time period sufficiently shorter than a time period during which the packet can be stayed in the buffer. For example, the number is fixed to be one or two (see, Japanese republication of PCT international application No. A1 2002-532000).

According to the conventional method, however, the time period during which a packet can be stored in a buffer cannot be fully utilized. In other words, even in cases where there is a time until the restructuring of the packet, the number of retransmission requests once reaches a predetermined number of times, it is treated as an error without requesting a further retransmission request.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### BRIEF SUMMARY OF THE INVENTION

According to an embodiment of the present invention, there is provided a transmitting apparatus for transmitting data to a receiving apparatus, comprising: a generating portion configured to generate a packet by adding a processing time in which said packet is processed at said receiving apparatus to said transmitting data; a transmitting portion configured to transmit said packet; a timer portion configured to count a current time; a memory portion configured to memorize a packet transmission time in which said packet is arrived from said transmitting portion to said receiving apparatus; a receiving portion configured to receive a request signal from said receiving apparatus, which request a retransmission of said packet; and an instructing portion configured to instruct said transmitting portion to retransmit said packet based on said current time, said processing time and said packet transmission time, where said request signal is received.

### BRIEF DESCRIPTION OF THE DRAWINGS

The accompanying figures are provided by way of example, without limiting the broad scope of the invention or various other embodiments, wherein:

FIG. 1 is a block diagram of a transmitter according to an embodiment of the present invention;

FIG. 2 is a block diagram of a receiver according to an embodiment of the present invention;

FIG. 3 shows a schematic block diagram of the wireless conversion processing portion of the transmitter according to the first embodiment of the present invention;

FIG. 4 is a timing chart of data in the case of using the transmitter according to the first embodiment of the present invention;

FIG. 5 is an operational flowchart in the case of using the transmitter according to the first embodiment of the present invention;

FIG. 6 is a schematic block diagram of a wireless conversion processing portion of the receiver according to a second embodiment of the present invention;

FIG. 7 is a timing chart of data in the case of using the receiver according to the second embodiment of the present invention;

FIG. 8 is an operational flowchart in the case of using the receiver according to the second embodiment of the present invention; and

FIG. 9 is a schematic block diagram of the wireless conversion processing portion of the receiver according to a third embodiment of the present invention.

### DETAILED DESCRIPTION OF THE INVENTION

Hereinafter, embodiments of the present invention will be explained in detail with reference to drawings. It should be understood that the present invention is not limited to the following embodiments.

### EMBODIMENT 1

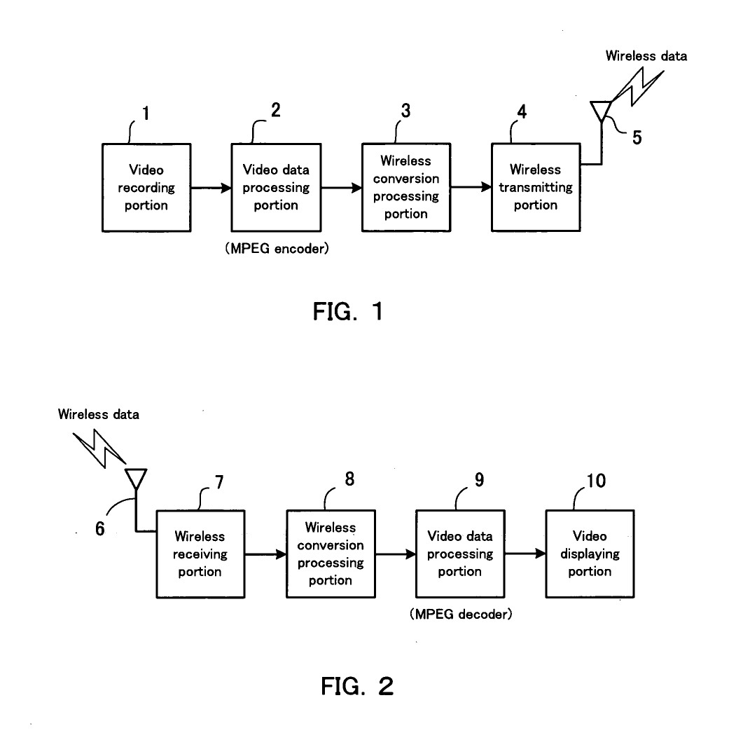

FIG. 1 is a block diagram of a transmitter according to an embodiment of the present invention.

As shown in FIG. 1, the transmitter is provided with a video recording portion 1, a video data processing portion (MPEG encoder) 2 for encoding the signal from the video recording portion 1 into a MPEG format signal, a wireless conversion processing portion 3 for converting the MPEG format signal from the video data processing portion 2 into a wireless signal, and a wireless transmitting portion 4 for wirelessly transmitting the signal from the wireless conversion processing portion 3.

The video signal recorded in the video recording portion 1 is encoded into an MPEG format video signal by the video data processing portion 2, and then converted into a wireless signal by the wireless conversion processing portion 3. The wireless signal is transmitted by the wireless transmitting portion 4 via the transmitting antenna 5 as wireless data.

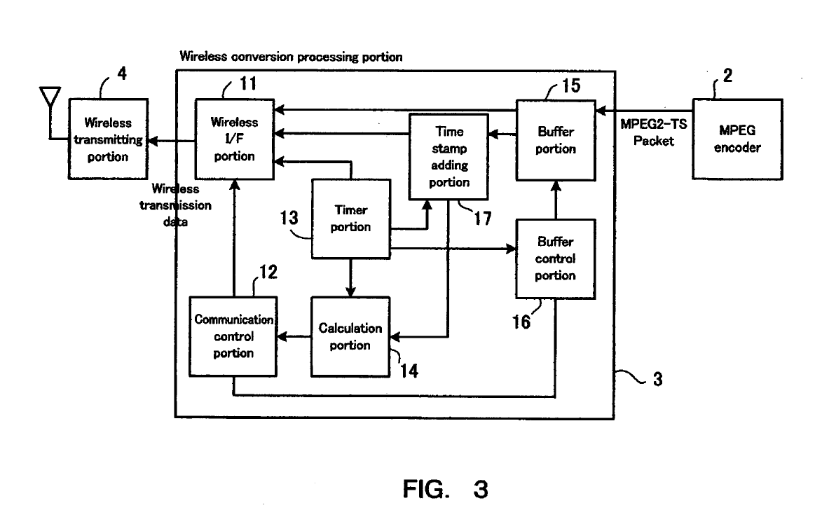

FIG. 2 is a block diagram of a receiver according to the first embodiment of the present invention.

As shown in FIG. 2, the receiver is provided with a wireless receiving portion 7 for receiving wireless data received via the receiving antenna 6, a wireless conversion processing portion 8 for converting the signal from the wireless receiving portion 7, a video data processing portion (MPEG decoder) 9 for decoding the signal from the wireless conversion processing portion 8 into a video signal, and a video displaying portion 10 for displaying the video signal from the video data processing portion 9.

The wireless data inputted to the receiving antenna 6 is received by the wireless receiving portion 7 and then converted into video format data by the wireless conversion processing portion 8. The converted video data is decoded into a MPEG signal by the video data processing portion 9 and displayed on the video displaying portion 10.

FIG. 3 shows the block diagram of the wireless conversion processing portion 3 of the transmitter shown in FIG. 1.

As shown in FIG. 3, this transmitter is characterized in the wireless conversion processing portion 3 surrounded with a solid line and connected to the wireless transmitting portion 4 and the video data processing portion (MPEG encoder) 2.

This wireless conversion processing portion 3 receives data from the video data processing portion (MPEG encoder) 2 and then transfers the data as wireless transmission data to the wireless transmitting portion 4.

As shown in FIG. 3, the wireless conversion processing portion 3 is provided with a wireless interface (wireless I/F) portion 11 for controlling an interface for the wireless data and the video data, a communication control portion 12 for controlling the entire communication in the wireless conversion processing portion 3, a timer portion 13, a calculation portion 14, a buffer portion 15 for temporarily storing a packet, and a buffer control portion 16 for controlling the buffer portion 15.

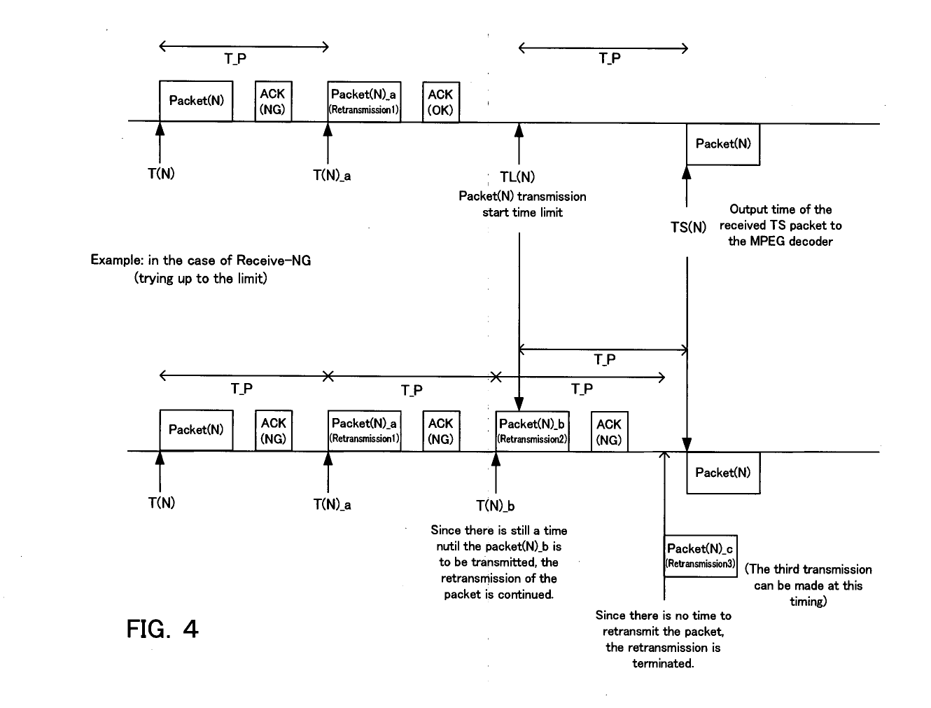

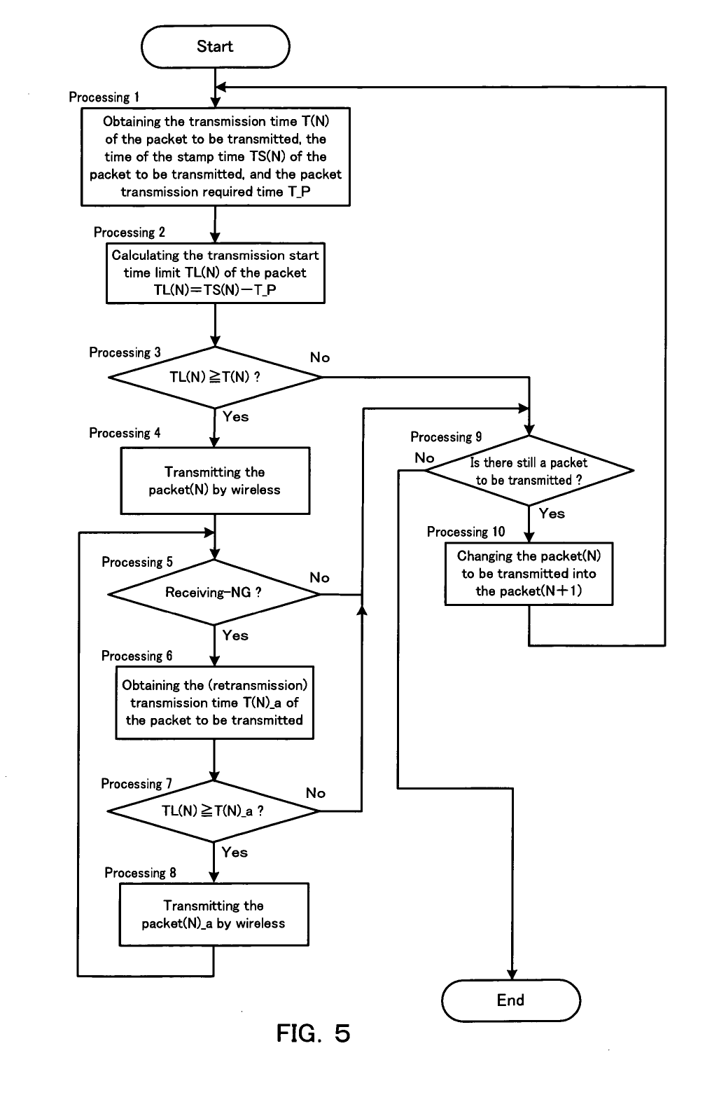

FIG. 4 is a timing chart of data communication in the case of using the aforementioned transmitter, and FIG. 5 is a flowchart explaining the operation of the transmitter.

The operation of the transmitter will be explained with reference to FIGS. 3 to 5.

First, a video signal is outputted from the video recording portion 1. The video signal is encoded by the video data processing portion (MPEG encoder) 2 to be outputted as an MPEG2-TS packet. This MPEG2-TS packet is stored in the buffer portion 15 of the wireless conversion processing portion 3.

Next, the buffer portion 15 transfers the data stored in the buffer portion 15 to the wireless I/F portion 11. At this time, the timer portion 13 sends the time when the data from the video data processing portion (MPEG encoder) 2 is inputted into the wireless conversion processing portion 3 to a time stamp adding portion 17. This time stamp adding portion 17 combines the data from the buffer portion 15 with the time from the timer portion 13 and transfers the data with the time to the wireless transmitting portion 4 via the wireless I/F portion 11. The wireless transmitting portion 4 transmits the data by wireless.

The processing will be initiated from START in the flowchart shown in FIG. 5, and the routine proceeds to Processing 1.

First, the transmission time T(N) of a packet which is currently to be transmitted, the time of the stamp time TS(N) of the packet and the packet transmission required time T_P are obtained (Processing 1).

In the wireless conversion processing portion 3 shown in FIG. 3, the calculation portion 14 obtains the transmission time T(N) of the MPEG2-TS packet (N), which is currently to be transmitted, from the timer portion 13 and the time of the stamp time TS(N) of the packet (N) from the time stamp adding portion 17. The time of the stamp time TS(N) represents the time when video data is outputted from the wireless conversion processing portion 8 of the receiver side to a video processing portion 9 (MPEG decoder) of the receiver side.

In this specification, the aforementioned “packet transmission required time T_P” is defined as the time period required for completing the transmission of a single packet (not including the time period for re-transmitting the packet). In this embodiment, the packet transmission required time T_P is treated as a fixed value. Although it is considered that the packet transmission required time T_P changes as the transmission distance changes, it is assumed that no dynamic change of the packet transmission required time T_P is made during the communication, assuming that the transmitter and the receiver are immovably installed.

The sum of the maximum value of the transmission required time T_P during which the wireless conversion processing portion 3 can transmit the packet and the delay time due to the transmitting/receiving processing is defined as the packet transmission required time T_P. This is represented by the following equation: (Maximum value of the transmission required time in the case of the maximum transmission distance)+(Delay due to the transmitting/receiving processing)=T_P.

FIG. 4 shows the timing of the packet transmission time T(N), the time of the stamp time TS and the packet transmission required time T_P.

Next, the transmission start time limit TL(N) of the packet N is calculated (Processing 2). That is, the calculation portion 14 calculates the packet transmission start time limit TL(N) for outputting the packet N toward the MPEG decoder 9 of the receiver from the packet transmission time T_P and the time of the stamp time TS(N) obtained at the processing 1. The calculation is made by the following equation.

TL(N)=TS(N)−T_{—}P

FIG. 4 shows the timing of the packet transmission start time limit TL(N) for outputting the packet (N) toward the MPEG decoder 9 of the receiver.

The calculation portion 14 sends the packet transmission time T(N) and the packet transmission start time limit TL(N) to the communication control portion 12.

The communication control portion 12 compares the packet transmission start time limit TL(N) and the packet transmission time T(N). If TL(N)≧T(N), the routine proceeds to Processing 4. This relation is represented by the following formula. (the time interval between the transmission start time limit of the packet (N) and the output time of the packet to the MPEG decoder of the receiver)≧(the transmission (retransmission) required time of the current packet T(N)). In other words, this means that there is a time to transmit (retransmit) the packet (N). On the other hand, if TL(N)<T(N), the routine proceeds to Processing 9.

Next, the communication control portion 12 instructs the wireless I/F portion 11 and the buffer control portion 16 to transmit the packet (N) (Processing 4). That is, the transmission data is sent to the buffer portion 15 and the wireless I/F 11, and then the data is sent to the wireless transmitting portion 4, thereby wirelessly transmitting the MPEG2-TS packet.

Next, in FIG. 2, the wireless receiving portion 7 returns a receive-OK signal to the transmitter when there is no error in the received packet. The wireless transmitting portion 4 shown in FIG. 1 receives the receive-OK signal and sends it to the wireless conversion processing portion 3. In this case, the routine proceeds to Processing 9.

On the other hand, the wireless receiving portion 7 returns a receiving-NG signal to the transmitter when there is an error in the received packet. The wireless transmitting portion 4 shown in FIG. 1 receives the receive-NG signal and sends it to the wireless conversion processing portion 3. In this case, the routine proceeds to Processing 6.

In FIG. 4, the aforementioned receive-OK signal is shown as “ACK(OK)” and the receive-NG signal is shown as “ACK(NG).”

When receiving the receive-NG signal “ACK(NG),” the communication control portion 12 receives the transmission time T(N)_a from the timer portion 13 to discriminate whether the packet (N) is to be retransmitted.

Next, the communication control portion 12 discriminates whether the transmission time T(N)_a has reached the transmission start time limit TL(N). If TL(N)≧T(N)_a, the routine proceeds to Processing 8 to execute the transmission of the packet (N)_a (i.e., retransmission of the packet (N)). To the contrary, if TL(N)<T(N)_a, the routine proceeds to Processing 9 without trying to retransmit the packet (N)_a.

Next, in accordance with the instruction of the communication control portion 12, each block executes the transmission of the packet (N)_a (i.e., retransmission of the packet (N)), and then the routine proceeds to Processing 5.

Subsequently, the communication control portion 12 discriminates whether there exists a packet (N+1) to be sent subsequent to the packet (N). If it is discriminated that there is the packet (N+1), the routine proceeds to Processing 10. If there is no packet, the routine proceeds to “END.” Then, the processing terminates.

Next, the communication control portion 12 changes the packet to be sent from the packet (N) to the packet (N+1), and then the routine returns to Processing 1.

As explained above, the communication according to the present invention can be realized by executing Processing 1 to Processing 10 every packet transmission.

It is possible to calculate the maximum number of retransmissions by the calculation portion 14 by the equation of [the maximum number of retransmissions=TS(N)−T(N)/T_P] to decide whether the packet is to be retransmitted by comparing the current number of retransmissions and the maximum number of retransmissions.

In cases where the transmission distance changes, the change of the communication time T_P is detected depending on the transmission distance change to update the T_P value. With this updated T_P value, the aforementioned processing can be performed.

In this embodiment, although the video data processing portion 2 of the transmitter and the video data processing portion 9 of the receiver are shown as an MPEG encoder and an MPEG decoder, respectively, another processing method can be employed in the processing portions.

Furthermore, in this embodiment, although the transmitting data is explained as an MPEG2-TS packet, the data is not limited to such MPEG2-TS packet so long as the communication is performed by a packet method.

The calculation of the packet transmission required time T_P will be explained as follows.

The processing is executed in Processing 1. In Processing 1, the communication control portion 12 transmits a test packet TEST(N) to be used for calculating the packet transmission required time T_P. The time when the test packet TEST(N) is transmitted is denoted as TEST_T(N). When the test packet TEST(N) is transmitted, a packet receive signal ACK(N) corresponding to the test packet TEST(N) is returned from the receiver. The time when the transmitter received the packet receive signal ACK(N) is denoted as ACK_T(N). It doesn't matter whether the content of the packet receive signal is “OK” or “NG.” The time T_P required for the test packet TEST_T(N) to be transmitted will be shown as the equation of T_P(N)=ACK_T(N)−TEST_T(N).

Subsequently, during Processing 1, the next test packet TEST(N+1) is transmitted, and the time T_P(N+1) required for the next test packet to be transmitted is obtained by performing the calculation similar to the calculation for the time T_P(N). This calculation will be repeated by a predetermined number M of times, and the maximum value T_P_MAX will be selected among the obtained time T_P(N), T_P(N+1), T_P(N+2), . . . and T_P(N+M−1). The predetermined number M of times is an arbitrary fixed value. In this embodiment, M=10.

The packet transmission required time T_P can be obtained by adding the time T_ACK required to initiate the actual transmission after receiving the packet receive signal ACK(N) to the time T_P MAX, i.e., T_P=T_P_MAX+T_ACK. Since the time T_ACK is a value determined at the time of design, the time T_ACK should be recorded at the time of design.

### EMBODIMENT 2

A receiver according to Embodiment 2 of the present invention will be explained. In this embodiment, the receiver discriminates whether a retransmission request is to be sent based on a calculation result.

A transmitter and a receiver of this embodiment are the same as the transmitter and the receiver shown in FIGS. 1 and 2, respectively. Therefore, the detailed explanation will be omitted by allotting the same reference numerals.

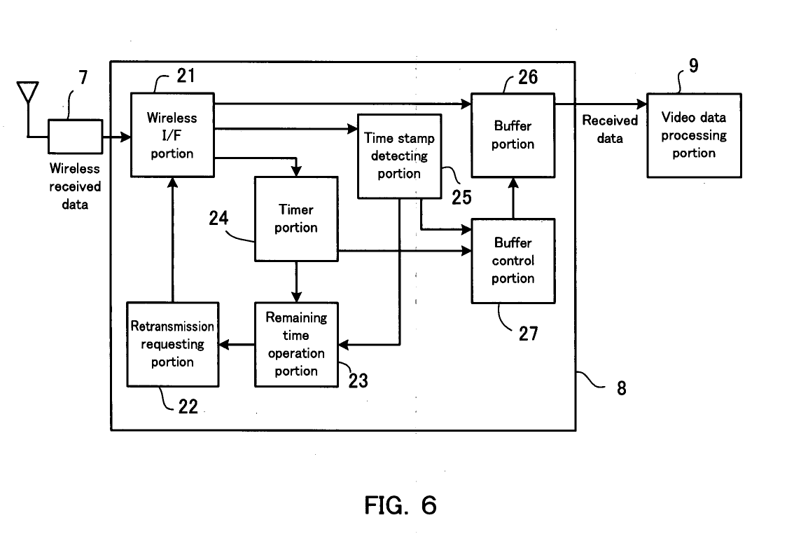

FIG. 6 is a detailed block diagram showing the wireless conversion processing portion 8 as shown in FIG. 2. As shown in FIG. 6, this receiver has a characteristic wireless conversion processing portion 8 surrounded by the actual line, which is connected to the wireless receiving portion 7 and the video data processing portion 9.

The wireless conversion processing portion 8 receives a wireless signal from the wireless receiving portion 7 and transfers video data to the video data processing portion 9.

As shown in FIG. 6, the wireless conversion processing portion 8 is provided with a wireless interface (wireless I/F) portion 21 for controlling the interface of the wireless data and the video data, a timer portion 24, a remaining time operation portion 23, a retransmission requesting portion 22, a time stamp detecting portion 25, a buffer portion 26 for temporarily storing a packet and a buffer control portion 27 for controlling the buffer portion 26.

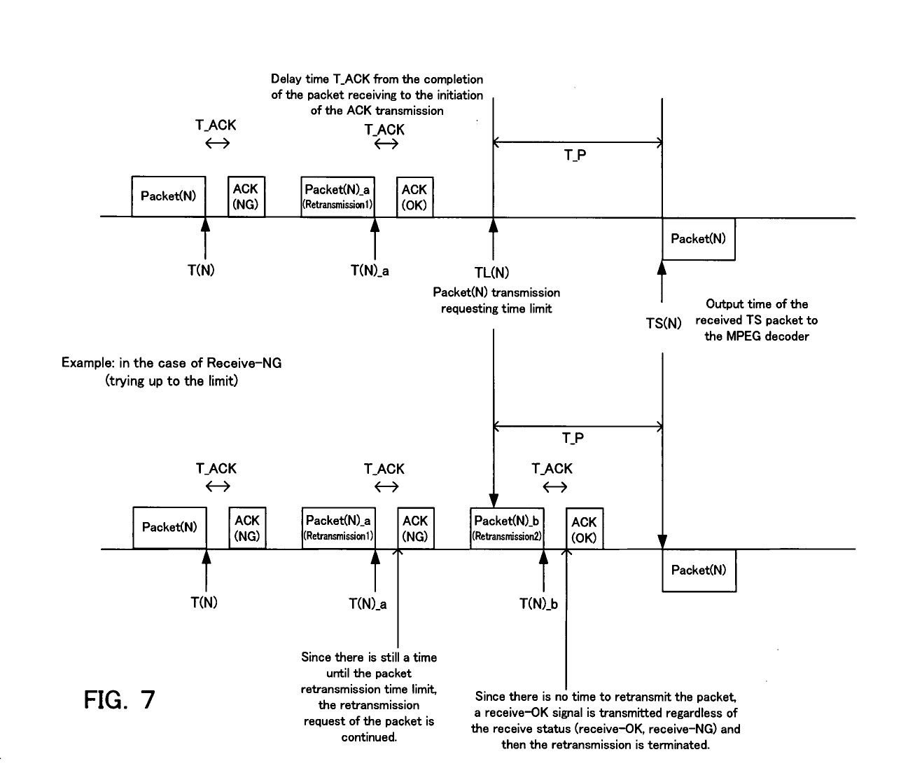

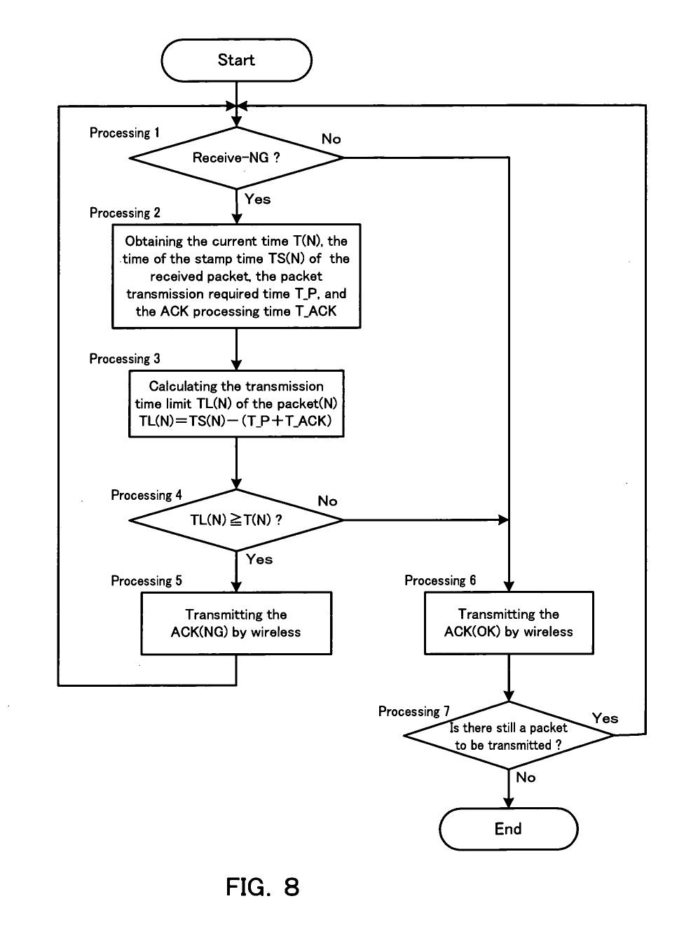

FIG. 7 is a timing chart of data communication in the case of using the receiver, and FIG. 8 is a flowchart explaining the operation of the receiver.

The operation of this receiver will be explained with reference to FIGS. 6 to 8.

A radio wave received by the antenna 6 is detected/demodulated in the wireless receiving portion 7 and then inputted to the wireless I/F portion 21. In this wireless I/F portion 21, the interface for wireless data and vide data is controlled, and processing normally carried out in a wireless transfer system, such as packet processing, error correction processing and acknowledge reply processing, will be performed.

Since the timer portion 24 shares time information between the receiver and the transmitter or within the entire network, the timer portion 24 is synchronized with a timer (not shown) provided in the transmitter or a certain terminal of the network to show the reference time of the time stamp.

The time stamp detecting portion 25 detects the time stamp from the received real time data (MPEG2-TS packet) and transfers the detected time stamp to the buffer controlling portion 27 and the remaining time operation portion 23.

The buffer portion 26 stores the received MPEG2-TS packet to absorb Jitter on the wireless transfer system.

The buffer controlling portion 27 reads out corresponding MPEG2-TS packet from the buffer portion 26 when the time shown by the time stamp detected by the time stamp detecting portion 25 coincides with the reference time shown by the timer portion 24, and outputs the MPEG2-TS packet to the video data processing portion 9.

The remaining time operation portion 23 calculates the remaining time from the current time shown by the timer portion 24 to the time when an MPEG2-TS packet is read out from the buffer portion 26 shown by the time stamp from the time stamp detecting portion 25.

The retransmission request portion 22 instructs the wireless I/F portion 21 to transmit a retransmission request to the transmitter if the remaining time calculated by the remaining time operation portion 23 is sufficient, and instructs the I/F portion 21 not to transmit a retransmission request if the remaining time is not sufficient even in the case where the received packet is NG.

In FIG. 8, processing is initiated from “START” in the flowchart, and then the routine proceeds to Processing 1. The wireless I/F portion 21 discriminates whether there is an error in the received packet (Processing 1). If the receiving status is acceptable (receive-OK), a receive-OK signal ACK(OK) is returned to the transmitter and then the routine proceeds to Processing 6.

However, if an error is detected in the received packet or an error remains regardless of the error correction, a retransmission request as error processing is prepared, and then the routine proceeds to Processing 2.

The error MPEG2-TS packet may be stored in the buffer portion 26 with a signal showing that the packet contains an error added thereto. Alternatively, the packet containing an error may not be stored in the buffer portion 26.

Next, the remaining time operation portion 23 obtains the current time T(N) on the network from the timer portion 24 and the time TS(N) shown by the time stamp of the packet sent from the time stamp detecting portion 25 to which the received MPEG2-TS packet (N) is added. The time TS(N) shown by the time stamp shows the time when the received data is outputted from the buffer portion 26 to the video data processing portion 9.

The time period from the time when a retransmission request of a single packet is sent to the transmitter to the time when the packet is received will be referred to as T_P. In the case of retransmission, since a MPEG2-TS packet stored in the buffer portion 15 of the transmitter is transmitted, the value of T_P is regarded as almost a fixed value.

In this embodiment, a retransmission delay time measuring means for measuring the aforementioned time period T_P may be equipped.

In this embodiment, the processing time from the packet receive time to the time when a receive-OK signal (ACK(OK)) or a receive-NG signal (ACK(NG)) is transmitted will be referred to as T_ACK. This T_ACK is a value specified in a wireless transfer system, and is almost a fixed value determined by the ACK return method.

FIG. 7 shows the current time T(N) on the network, the time TS(N) shown by the time stamp, the time period T_P from the time when a retransmission request of a single packet is transmitted to the transmitter to the time when the packet is received, the timing of the processing time T_ACK from the time when the packet receipt is completed to the time when a transmission of a receive-OK signal (ACK(OK)) or a receive-NG signal (ACK(NG)) is performed, and the timing of the receive-OK signal or the receive-NG signal.

Next, the remaining time operation portion 23 calculates the remaining time TL(N) which is a time limit when the received MPEG2-TS packet is outputted from the buffer portion 26 to the video data processing portion 9 from three kinds of times obtained in Processing 2. The calculation formula is shown as follows.

TL(N)=TS(N)−(T_{—}P+T_{—}ACK)

FIG. 7 shows the timing of the remaining time TL(N).

Next, the remaining time operation portion 23 compares the remaining time TL(N) with the current time T(N) (Processing 4). If TL(N)≧T(N), the routine proceeds to Processing 5. This means that there is a sufficient time until the buffer portion 26 outputs the data to the video data processing portion 9 even in cases where the packet (N) is retransmitted. If TL(N)<T(N), the routine proceeds to Processing 6. The remaining time operation portion 23 transfers the comparison result to the retransmission requesting portion 22.

Then, the retransmission requesting portion 22 instructs the wireless I/F portion 21 to transmit a receive-NG signal ACK(NG) in accordance with the instruction from the remaining time operation portion 23 (Processing 5).

Next, when the receive-NG signal ACK(NG) is transmitted via the wireless I/F portion 21, a packet (N)_a will be retransmitted from the wireless transmitter. In the wireless I/F portion 21, it is recognized that the received MPEG2-TS packet is a retransmitted packet.

In cases where the MPEG2-TS packet from which an error was detected is stored in the buffer portion 26, the packet with an error will be overwritten by the retransmitted MPEG2-TS packet to prevent the storing of both the packets, and then the routine proceeds to Processing 1.

Next, in Processing 1, the received packet judged to be OK by the wireless I/F portion 21 will be stored in the buffer portion 26, and the buffer controlling portion 27 will compare the time shown by the time stamp of the packet with the time shown by the timer portion 24. Then, at the timing when both the times become equal, the MPEG2-TS packet is read out of the buffer portion 26 and then outputted to the video data processing portion 9.

There is a high possibility that the received packet which is judged to be TL(N)<T(N) in Processing 4 passes the time TS(N) soon even if it is retransmitted. Therefore, the retransmission requesting portion 22 stops requesting the retransmission and instructs the wireless I/F portion 21 to transmit a receive-OK signal ACK(OK).

The MPEG2-TS packet in which an error remains eventually can be discarded from the buffer portion 26. Furthermore, although such MPEG2-TS packet will be read out of the buffer portion 26 at the time shown by the time stamp, the packet can be outputted to the video data processing portion 9 together with an error signal.

Next, the wireless I/F portion 21 discriminates whether there exists a packet (N+1) subsequent to the packet (N). If there is the packet (N+1), the routine proceeds to Processing 1.

Then, if a receive terminate instruction is issued by the controlling portion (not shown) of the wireless receiver and therefore the receive operation terminates, the routine proceeds to “END” and the processing terminates.

In order to transmit the retransmission request for a longer time, the receiver may be equipped with a fixed value adding means for adding a fixed value to the time stamp attached to the received MPEG2-TS packet to prolong the time required to read the MPEG2-TS packet from the buffer portion 26.

In the MPEG2-TS packet in which an error is detected by the wireless I/F portion 21, there is a possibility that the error occurred in the time stamp portion. Therefore, the receiver may be equipped with a retransmission requesting means that assumes the time stamp of the packet in which an error occurred from the time stamp of a normally received packet before/after the error packet or a previously normally received and the current time shown by the timer portion 24 and that requests a retransmission of the packet by the number of a certain fixed value without requesting a retransmission using a time stamp in the case where the assumption result and the time stamp of the actually received packet are greatly different with each other.

Furthermore, the receiver may be equipped with a means for discarding a received packet as a delayed packet when the current time shown by the timer portion 24 has passed the time of the time stamp of the received packet in the case where an error was not detected because of too large transfer delay due to some reasons.

Although the above explanation is made using a wireless transfer system and an MPEG2-TS packet, similar effects can be obtained by similar processing by using another transfer system which performs a retransmission or another real time data.

In this embodiment, since the retransmission requesting portion capable of changing the retransmission request status (retransmission request or non-request) depending on the time of the time stamp added by the transmitter side, it is possible to execute the retransmission as long as time permits. Furthermore, it becomes possible to overcome the problem that a real time performance cannot be secured because of the too large transfer delay of the retransmitted real time data.

### EMBODIMENT 3

Next, a receiver according to the third embodiment of the present invention will be explained. In this embodiment, it is discriminated whether the packet erroneously received is the data which is necessary and effective to reconstruct the packet or whether the packet erroneously received is the data unnecessary and invalid to reconstruct the packet, and no retransmission request will be made in the case where the packet is the unnecessary and invalid data.

Since the transmitter and the receiver are similar to those of Embodiment shown in FIGS. 1 and 2, the detailed explanation thereof will be omitted.

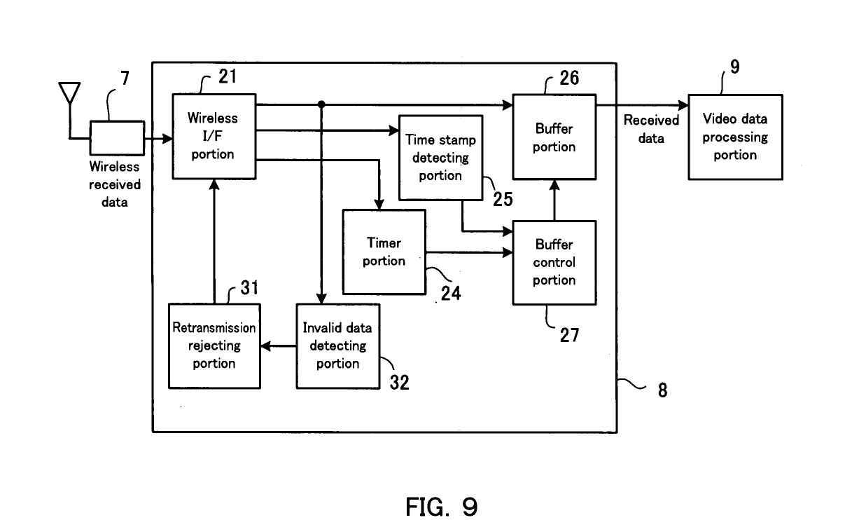

FIG. 9 is a block diagram of the receiver.

As shown in FIG. 9, this receiver has a characteristic wireless conversion processing portion 8 surrounded by a solid line and connected to the wireless receiving portion 7 and the video data processing portion 9.

The wireless conversion processing portion 8 receives a wireless signal from the wireless receiving portion 7 and then transfers the video data to the video data processing portion 9.

As shown in FIG. 9, the wireless conversion processing portion 8 is provided with a wireless interface (wireless I/F) portion 21 for controlling an interface for wireless data and video data, a timer portion 24, an invalid data detecting portion 32, a retransmission rejecting portion 31 for discriminating whether a retransmission request is to be issued, a time stamp detecting portion 25, a buffer portion 26 for temporarily storing a packet, and a buffer controlling portion 27 for controlling the buffer portion 26.

The invalid data detecting portion 32 detects whether the received MPEG2-TS packet is invalid data (e.g., NULL packet or error packet) The retransmission rejecting portion 31 rejects sending of the retransmission request via the wireless I/F portion 21 toward the transmitter even in the case where an error occurred during the transferring process of the packet is detected in the received packet discriminated to be invalid by the invalid data detecting portion 32.

First, the data transmitted from the wireless transmitter is received by the wireless receiving portion 7 via the antenna. The wireless signal received by the wireless receiving portion 7 is subjected to processing normally performed in a wireless transfer system, such as detection, modulation, packet processing in the wireless I/F portion 21, and error collection, and then outputted as MPEG2-TS packet to which a time stamp is added. When an error is detected in the received packet, the wireless I/F portion 21 prepares to transmit a receive-NG signal ACK(NG) toward the transmitter.

The MPEG2-TS packet that an error was detected is transferred to the invalid data detecting portion 32 to detect whether the data is invalid. For example, in MPEG2-TS packet, there exists a packet called “NULL packet.” In the regulation of ISO/IEC13818-1, there exists a region called “PID (Packet Identifier). It is possible to detect that the value is 0×1FFF. Since this NULL packet does not include effective data necessary to reconstruct the data, there will be no problem even if the packet is discarded.

If it is discriminated by the invalid data detecting portion 32 that MPEG2-TS packet in which an error occurred is a NULL packet for example, based on the discrimination, the retransmission rejecting portion 31 instructs the wireless I/F portion 21 not to issue a retransmission request.

On the other hand, in the case where it is discriminated that the packet is not a NULL packet, the retransmission rejecting portion 31 does not instruct the wireless I/F portion 21 not to issue a retransmission request. Therefore, the wireless I/F portion 21 transmits a retransmission request in accordance with a prescribed method for a wireless transfer system.

In cases where the header of the MPEG2-TS packet includes a region showing a possible error of the MPEG2-TS packet and the set value of the region is effective, a means for processing the invalid data can be provided.

There is a possibility that packets which are not required to decode with an MPEG decoder are contained in MPEG2-TS packets transmitted from the transmitter. Although these non-required packets are meaningful data, they are not required only at the time of decoding. A means for regarding such MPEG2-TS packet not required at the time of decoding as invalid data can be equipped.

In this embodiment, no retransmission request is not issued at the receiver side even if a transmission error occurred in the data that is meaningless as real time data. Therefore, it becomes possible to prevent an unnecessary occupation of a transmission band caused by transmitting a retransmission request of the packet which will be ignored at an application side (e.g., MPEG decoder).

The receiver explained in this embodiment can be combined with Embodiment 1 and/or Embodiment 2.

In the case in which this embodiment is combined with Embodiment 2, a discrimination means for discriminating whether the received packet is a NULL packet is added to the receiver of Embodiment 2. If it is discriminated that the received packet is a NULL packet, the routine proceeds to Processing 6. To the contrary, if it is discriminated that the received packet is not a NULL packet, the routine proceeds to Processing 5. Thus, the processing as explained in Embodiment 2 can be executed. According, efficient data processing can be executed.

Furthermore, in this embodiment, although the video data processing portion is constituted by a MPEG encoder/decoder, the MPEG method is one of examples, and therefore another processing method can be employed

Furthermore, although the transmission data is explained as an MPGE2-TS packet in this embodiment, the transmission data is not limited to an MPEG2-TS packet so along as the communication is made in a packet method.

According to the aforementioned preferred embodiments, it is possible to provide a transmitter capable of retransmitting a packet up to the reconstruction time limit and a receiver capable of transmitting a retransmission request up to the reconstruction time limit by effectively using the waiting time for the packet reconstruction.

Furthermore, in cases where a receiving error occurred in a packet which is not required for the data reconstruction, it is possible to provide a receiver that executes processing without transmitting a retransmission request.

While illustrative embodiments of the present invention have been described herein, the present invention is not limited to the various preferred embodiments described herein, but includes any and all embodiments having modifications, omissions, combinations (e.g., of aspects across various embodiments), adaptations and/or alterations as would be appreciated by those in the art based on the present disclosure. The limitations in the claims are to be interpreted broadly based the language employed in the claims and not limited to examples described in the present specification or during the prosecution of the application, which examples are to be construed as non-exclusive. For example, in the present disclosure, the term “preferably” is non-exclusive and means “preferably, but not limited to.” Means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited.

What is claimed is:

1. A transmitting apparatus for transmitting data to a receiving apparatus, comprising:
a generating portion configured to generate a packet by adding a processing time in which said packet is processed at said receiving apparatus to said transmitting data;
a transmitting portion configured to transmit said packet;
a timer portion configured to count a current time;
a memory portion configured to memorize a packet transmission time in which said packet is arrived from said transmitting portion to said receiving apparatus;
a receiving portion configured to receive a request signal from said receiving apparatus, which request a retransmission of said packet; and
an instructing portion configured to instruct said transmitting portion to retransmit said packet based on said current time, said processing time and said packet transmission time, where said request signal is received.

2. A transmitting apparatus according to claim 1, wherein said instructing portion instructs said transmitting portion to retransmit said packet where said current time is earlier than subtracting time obtained by subtracting said packet transmission time from said processing time.

3. A transmitting apparatus according to claim 2, wherein said instructing portion instructs said transmitting portion not to retransmit said packet where said current time is later than said subtracting time.

4. A transmitting apparatus according to claim 1, furthermore comprising:
a calculating portion configured to calculate said packet transmission time based on a transmitting time in which a test packet is transmitted and a receiving time in which a return packet corresponding to said test packet is received.

5. A transmitting apparatus according to claim 4, wherein said calculating portion calculates a maximum number of retransmission of said packet based on said transmitting time and said receiving time.

6. A transmitting method for transmitting data to a receiving apparatus, comprising:
generating a packet by adding a processing time in which said packet is processed at said receiving apparatus to said transmitting data;
transmitting said packet;
counting a current time;
receiving a retransmission request of said packet from said receiving apparatus; and
instructing to retransmit said packet based on said current time, said processing time and said packet transmission time in which said packet is arrived to said receiving apparatus, where said request signal from said receiving apparatus, which request a retransmission of said packet, is received.

7. A receiving apparatus for receiving data which is transmitted from a transmitting apparatus, comprising:
a receiving portion configured to receive a packet transmitted from said transmitting apparatus, which is obtained by adding a processing time in which said packet is processed at said receiving apparatus to said transmitting data;
a timer portion configured to count a current time;
a buffer portion configured to hold said packet until said processing time;
a calculating portion configured to calculate a remaining time in which said packet is outputted from said buffer portion based on said processing time and said current time; and
a transmitting portion configured to transmit a request signal which requests a retransmission of said packet to said transmitting apparatus until said remaining time which reaches a predetermined value where a receive error of said packet occurs.

8. A receiving apparatus according to claim 7, furthermore comprising:
a checking portion configured to check a header of said packet where said receive error of said packet occurs;
wherein said transmitting portion cease from transmitting said request signal where said packet is invalid.

9. A receiving apparatus according to claim 8, wherein said invalid packet is data which is not required to reconstruct said transmitting data.

10. A receiving apparatus according to claim 9, wherein said invalid packet is data which is null data.
